(19) United States
(12) Patent Application Publication
(10) Pub. No.: US 2010/0010399 A1
(43) Pub. Date: Jan. 14, 2010

(54) HYDRO DRIVEN MASSAGING APPARATUS

(76) Inventor: Dean L. Siebert, JR., Arlington Heights, IL (US)

Correspondence Address: Howard B. Rockman, 1 S 376 Summit Avenue, Court C, Oakbrook Terrace, IL, 60181, US

(21) Appl. No.: 12/169,415

(22) Filed: Jul. 8, 2008

(51) Int. Cl. A61H 7/00

(52) U.S. Cl. 601/105

(57) ABSTRACT

A water pressure driven massage apparatus for massaging portions of the human body includes a housing adapted to be placed in an ordinary shower enclosure while a user is in the shower. A water pressure operated power device is rotatably mounted in the housing, and a shower water diverter valve selectively delivers water under pressure to a nozzle that directs a jet of water to impinge upon and rotatively drive the water pressure operated power device. The power device is connected to a gear reduction drive train that converts the rotary motion of the water pressure operated power device to reciprocal motion A rod extends through the housing of the massage apparatus, and the rod is reciprocally driven by the gear reduction drive train. The outer end of the reciprocating rod is adapted to be attached to, or configured into the shape of, a variety of massaging devices.

### FIELD OF THE INVENTION

The present invention is a water-driven massaging apparatus, and more particularly a hydro-powered apparatus adapted to be used in an ordinary shower facility, and providing reciprocal motion to a longitudinal massage member adapted to massage selected portions of the human body.

### BACKGROUND OF THE INVENTION

Many devices are available today for massaging various portions of the human body, both male and female, including the back, legs and male and female genital organs. These devices provide a rotary massaging motion, a reciprocal massaging motion, or various combinations of both. These prior devices are primary electrically driven, such as the rotating genital massage device disclosed in U.S. Pat. No. 7,135,004. However, such electrically powered massage devices are not suitable for use by one desiring a massage while taking a shower. It is common knowledge that electrically powered devices should not be used in or near water due to the high risk of electrical shock and possible electrocution.

Thus, there is a need for a massage device powered by the water pressure developed at an ordinary shower head, which device can safely and conveniently be used to massage various portions of the body of the user while taking a shower.

Further, there is a need for a water pressure operated device for use in an ordinary shower facility that can translate hydraulic pressure generated at the shower head into reciprocal motion delivered to a massaging element that directly contacts the body portion the user desires to massage.

In addition, there is a need for a device using water pressure to drive a power train at a reduced speed, but at increased torque, to provide a satisfactory massage pressure to the human body without injuring the body portion being massaged.

Also, there is a need for a massaging device of the type described above that will cease operation if excessive massage force is applied to the apparatus.

### SUMMARY OF THE INVENTION

The present invention comprises a water pressure driven massage apparatus for massaging selected portions of the human body. The apparatus includes a housing having a water pressure operated power device, such as a plurality of circumferentially arrayed paddles or scoops, rotatably mounted inside the housing. An adapter for supplying water pressure from a shower head is also mounted in the housing, the water delivered under pressure from the shower head to impinge upon and rotate the water pressure operated power device. The power device is operably connected to a gear reduction drive train mounted in the housing, and the drive train converts the rotating motion of the power device to reciprocal motion. The reciprocal motion is delivered to a massage element that is operably connected to the output of the drive train.

### BRIEF DESCRIPTION OF THE DRAWINGS

Certain examples of the present invention are illustrated by the accompanying figures. It should be understood that the figures are not necessarily to scale and that details that are not necessary for an understanding of the invention, or that render other details difficult to perceive, may be omitted. It should be understood, of course, that the invention is not necessarily limited to the particular examples illustrated herein.

FIG. 1 is a front-side perspective view of the massage apparatus of the present invention, showing the water pressure/operated power device located inside the housing, the reciprocating massage element extending from the housing, and the source of water pressure extending from a shower diverter valve to a water jet nozzle extending through the housing and directed towards the water pressure operated power device;

FIG. 2 is a rear-side, partially cut-away perspective view of the massage apparatus of FIG. 1, showing an embodiment of a gear reduction drive train mechanism operably connected between the water pressure operated power device and the reciprocating massage element of the present invention;

FIG. 3 is an elevation cross-sectional view of an embodiment of the massage apparatus of the present invention, taken along line 3-3 of FIG. 1, and showing an elevation view of the gear reduction drive train shown in FIG. 2;

FIG. 4 is a schematic side elevation view of an embodiment of the water pressure operated power device of the present invention, taken along line 4-4 of FIG. 3, showing its connection to the gear reduction drive train shown in FIGS. 2 and 3;

FIG. 5 is an elevation detail view of another embodiment of the drive train of the present invention, illustrating an elliptical cam drive mechanism disposed between the gear reduction drive train and the reciprocating massage element; and

FIG. 6 is a perspective detail view of a further embodiment of the present invention, showing a helical gear drive train interposed between the water pressure operated power device and the reciprocating massage element of the present invention.

### DETAILED DESCRIPTION OF THE ILLUSTRATED EMBODIMENTS OF THE INVENTION

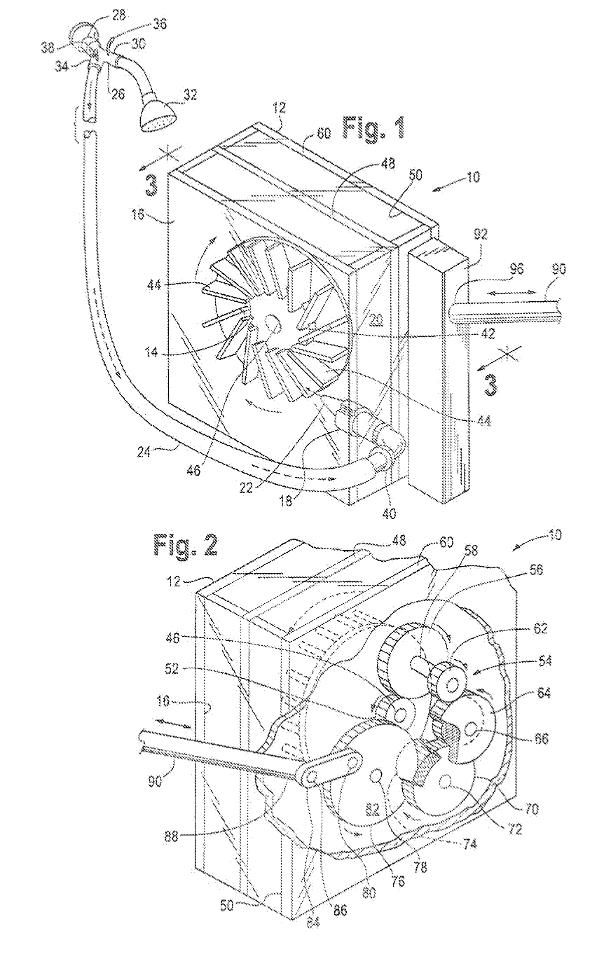

Referring to FIG. 1, the water pressure driven massage apparatus of the present invention is designated generally by the numeral 10. A housing 12 confines and rotatably supports water pressure operated powered device 14 in a first chamber 16 of housing 12. An adapter 18 is attached to and extends through the wall portion 20 of housing 12 and into chamber 16, and a water jet nozzle 22 is connected to the end of the adapter 18 extending into chamber 16. The opposite end of adapter 18 extending outside of chamber 16 through wall portion 20, is connected to a water delivery hose 24 that extends to and communicates with shower diverter valve 26. Shower diverter valve 26 is attached to the wall water outlet 28, and includes a first channel 30 directing water to shower head 32, and a second channel 34 attaching delivery hose 24 to the source of water pressure delivered through water outlet 28. Handles 36, 38 allow water to be selectively directed from outlet 28 to delivery hose 24, or to shower head 32, or to both the delivery hose 24 and the shower head 32 simultaneously.

The opposite end of water delivery hose 24 is connected to one end of adapter 18 via a releasable connector 40, as is known in the art of fluid connections. Water jet nozzle 22, having a hollow channel, is connected to the opposite end of adapter 18, such that water transmitted from second channel 34 of water outlet 28 through hose 24 will be transmitted through adapter 18 and will exit nozzle 22 under relatively high pressure.

Water pressure operated device 14 is mounted for rotation in chamber 16 of housing 12. As seen in FIG. 1, a hub 42 circumferentially mounts a plurality of paddles 44. The paddles 44 shown in FIG. 1 are flat, but it is understood that the paddles 44 may also be scoop-shaped or other shapes as are known in the art. A circular plate 45 is attached to the hub, 42 and to the lateral sides of paddles 44 to provide added strength to and reinforcement for the paddles. Hub 42 is mounted on a shaft 46, which shaft 46 extends through a wall 48 separating chambers 14 and 16 of housing 12. Shaft 46 extends through bushings (not shown) mounted in wall 48 as is known in the art, such that shaft 48, hub 42 and paddles 44 are rotatably mounted in chamber 16 of housing 12. Nozzle 22 is located tangentially adjacent paddles 44. When a water jet under pressure exits nozzle 22, the water jet impinges on sequential paddles 44, imparting rotating motion to hub 42 and to shaft 46. At the bottom of chamber 16 are a plurality of drain apertures (not shown) that allow water to drain out of chamber 16 and out of housing 12 and into the shown enclosure after the water has impinged upon paddles 44.

Wall 48 separates chamber 16 from a second chamber 50 forming part of housing 12. Rotatable shaft 46 extends through a water-tight aperture (not shown) in wall 48, and the terminus end of shaft 46 in chamber 50 mounts a pinion gear 52 that rotates with shaft 46. Referring to FIGS. 2 and 4, pinion gear 52 is the input to the gear reduction drive train generally designated by the numeral 54, which drive train is located in chamber 50 of housing 12. As seen in FIGS. 1 and 2, chambers 16 and 50 are isolated from each other by wall 48, whereby water from chamber 16 does not migrate into chamber 50. In the illustrated embodiment of FIGS. 2-4, gear reduction drive train 54 includes a gear 56 meshing with and driven by pinion gear 52. Gear 56 is mounted for rotation with shaft 58. Shaft 58 is mounted for rotation on wall 60 of housing 12, with bushings (not shown) rotatably mounting shaft 58 on wall 60, as in known in the art.

A pinion gear 62 is also mounted for rotation with shaft 58, and pinion gear 62 meshes with gear 64, the latter mounted for rotation with shaft 66. Shaft 66 is rotatably mounted to wall 60 with suitable bushings (not shown) as is known in the art. A pinion gear 68 (FIG. 4) is mounted on shaft 66, and shaft 66 is suitably mounted for rotation in wall 60, as is known in the art.

Pinion gear 68 meshes with and drives gear 70, wherein gear 70 is mounted for rotation on shaft 72. Shaft 72 also mounts a pinion gear 74, and pinion gear 74 meshes with drive gear 76 mounted for rotation on shaft 78. Shaft 78 is suitably mounted for rotation in housing 12.

Drive gear 76 includes a radially eccentric pin 80 mounted on one side of face 82 (FIG. 2) of drive gear 76. A link member 84 is rotatably attached to pin 80 at one end of the link member. A second end of link member 84 has a pin 86 attached thereto, and pin 86 extends through an aperture (not shown) at one end 88 of reciprocating rod 90 in a manner and for purposes to be described.

The gear reduction drive train 54 illustrated in FIGS. 2-4 is an example of one of several gear reduction drive trains that may be used in association with the present invention.

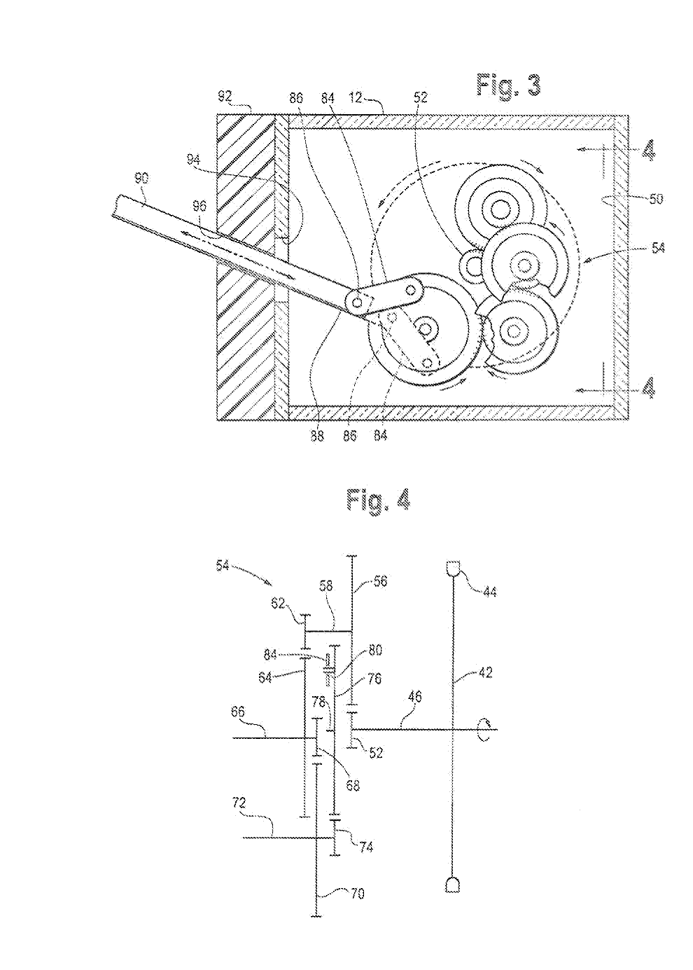

Referring to FIGS. 1 and 3, a rigid block 92 provides a support for reciprocating rod 90. Block 92 is attached to, and forms a part of housing 12. As seen in FIG. 3, housing 12 includes an aperture 94 through which rod 90 extends. A slanted channel 96 extends through block 92, and rod 90 extends through channel 96, as seen in FIG. 3. Channel 96 restricts the lateral, or radial, movement of rod 90, but the space between the walls of channel 96 and the outer surface of rod 90 is sufficient to allow axial movement of rod 90 in channel 96 without causing a significant degree of frictional resistance. The reciprocating motion of rod 90 is applied to the body portions of the user desired to be massaged, as will be explained.

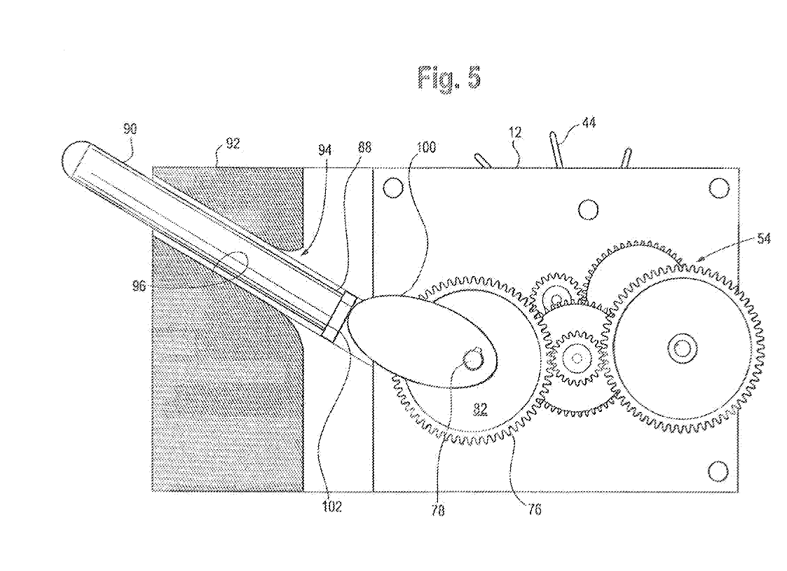

Referring to FIG. 5, an alternate configuration of the gear reduction drive train 54 of the embodiment of FIGS. 2-4 is illustrated. In this embodiment, like numerals are used to identify like parts in the embodiment of FIGS. 1-4. As seen in FIG. 5, an elliptical cam 100 is mounted on shaft 78 and the cam is attached to side face 82 of drive gear 76. As drive gear 76 rotates, cam 100 will rotate with shaft 78.

A cam follower 102 is mounted on end 88 of reciprocating rod 90, which cam follower 102 is urged into abutting contact with cam 100 by a spring (not shown) or other pressure applying device as is known in the art. As cam 100 is rotated by gear reduction drive train 54 and drive gear 76, the distance between shaft 78 and the outer surface of cam 100 in contact with cam follower 102 changes, driving rod 90 reciprocally in channel 96.

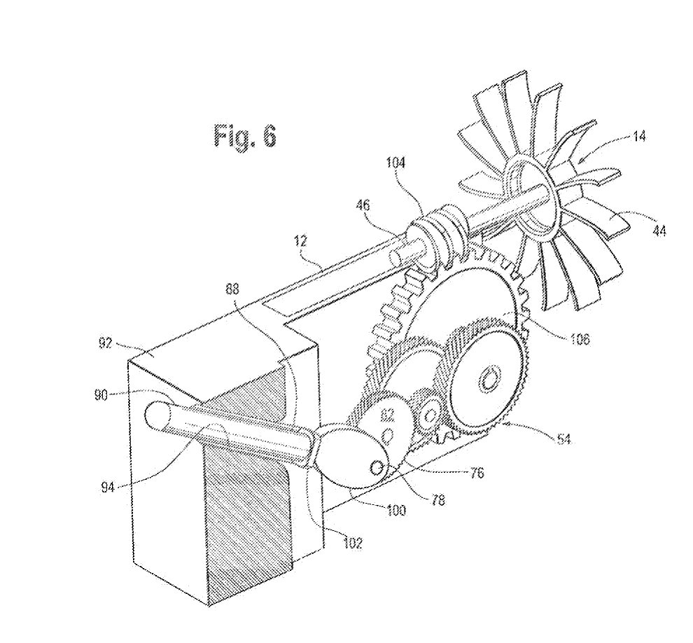

FIG. 6 illustrates a further drive train 54 embodiment for reciprocally driving rod 90 in channel 96. In this embodiment, water pressure operated device 14 and shaft 46 are drivingly connected to a helical drive gear 104. A helical driven gear 106 is rotatably driven by helical drive gear 104, as is known in the art. Driven gear 106 provides the input to gear reduction drive train 54, which is shown in the embodiment of FIGS. 1-5, and reduces the speed of drive gear 76. In this embodiment, as in the embodiment of FIG. 6, elliptical cam 100 is connected to and rotated by drive gear 76 to input reciprocal motion to cam follower 102 and rod 90.

Each of the gear reduction drive train embodiments 54 illustrated in FIGS. 2-4, 5 and 6 are configured to produce low speed, high torque reciprocal motion to rod 90, as described above. An attribute of these gear systems is the provision of a fail-safe condition. If massaging rod 90, or any massage equipment attached to rod 90, incurs a high resistance force value from the body portion being massaged, the reciprocal motion of rod 90 will succumb to the resistance force, and the paddles 44 and shaft 46 will cease rotating. The force of the water from jet nozzle 22 impinging paddles 44 will not be sufficient to rotate the paddle assembly against the high resistance force due to the configuration of gear reduction drive train 54.

Each of the drive trains 54 shown in FIGS. 2-6 are examples of drive trains that can be used in the present invention. However, it is to be understood that other drive train systems that produce the above-described speed and torque requirements may be substituted for the illustrated drive trains of FIGS. 2-6.

In operation, referring to the embodiment of the present invention illustrated in FIGS. 1-4, the housing 12 is placed on the floor of a shower enclosure, and the handle 38 of shower diverter valve 26 is rotated to the “on” position. Water flowing through hose 24 is ejected in a stream or jet from nozzle 22, which water stream impinges on paddles 44 of water pressure operated power device 14, rotating the power device 14 and shaft 46. Referring to FIGS. 2, 3 and 4, shaft 46 rotates pinion gear 52, which ultimately rotates driven gear 76 through gear reduction drive train 54. As driven gear 76 rotates as a result of the water stream delivered to paddles 44 and shaft 46, link member 84 moves in a reciprocal direction, as illustrated in FIG. 3. As link member 84 moves, rod 90 attached to link member 84 by pin 86 is reciprocally moved in channel 96 of block 92.

The outer end of rod 90, not shown, is adapted to be attached to various forms of massaging apparatus. For example, the outer end of rod 90 may be attached to a single or multiple roller device adapted to reciprocally roll over the portion of the body the user desires to massage while in the shower. Alternatively, the outer end of rod 90 is adapted to be attached to, or configured in the shape of, elements that mimic the genital organs of a human body, namely a penis or vagina. These latter devices could be used to stimulate the genital organs of the user in the shower, either male or female. Since no electricity is necessary to operate the apparatus 10, the massage apparatus may be used safely in the shower without harm to the user. The embodiments of FIGS. 5 and 6 may be operated by the user in the same manner as described above in relation to the embodiments of FIGS. 1-4. The ultimate reciprocating motion of rod 90 will similarly provide the massaging motion desired by the user.

The foregoing description of illustrated embodiments of the invention has been presented for purposes of illustration and description, and is not intended to be exhaustive or to limit the invention to the precise form disclosed. The description was selected to best explain the principles of the invention and practical application of these principals to enable others skilled in the art to best utilize the invention in various embodiments and various modifications as are suited to the particular use contemplated. It is intended that the scope of the invention not be limited by the specification, but as defined by the claims set forth below.

1. A water pressure driven massage apparatus for massaging portions of the human body, comprising:
a housing;
a water pressure operated power device rotatably mounted inside said housing;
a source of water pressure mounted in said housing, said source of water pressure adapted to selectively transmit water under pressure to impinge upon and rotate said water pressure operated power device;
said water pressure operated power device operably connected to a drive train, said drive train mounted in said housing, said drive train converting rotating motion from said water pressure operated power device to reciprocal motion;
a massage element mounted for reciprocal motion relative to said housing, said massage element adapted to massage a selected portion of the human body;
said drive train having a reciprocal moving output, the output of said drive train operably connected to said massage element, said drive train output providing reciprocal motion to said massage element.

2. The water pressure drive massage apparatus of claim 1, wherein:
said water pressure operated device includes a hub having a plurality of paddle elements extending radially from said hub, said source of water pressure adapted to apply water to impinge upon said paddles to rotate said water pressure operated power device.

3. The water pressure driven massage apparatus of claim 2, including:
a nozzle disposed in said housing, said nozzle attached at one end to said source of water under pressure, a second end of said nozzle adapted to direct said water under pressure to impinge upon said paddles.

4. The water pressure operated massage apparatus of claim 1, wherein said massage element comprises a rod attached through a mechanical linkage to said drive train.

5. The water pressure operated massage apparatus of claim 1, wherein said drive train produces a predetermined torque value for said reciprocal motion, said predetermined torque value enabling said reciprocal motion of said massage element to cease upon said massage element encountering a predetermined value of a force resisting said reciprocal motion.

6. The water pressure operated massage apparatus of claim 1, wherein:
said housing includes a first chamber and a second chamber;
said water pressure operated power device located in said first chamber;
said drive train located in said second chamber; and
said water pressure operated power device operatively connected to said drive train through a wall separating said first chamber from said second chamber.

7. The water pressure operated massage apparatus of claim 6, wherein:
said wall provides a waterproof barrier between said first and second chambers.

8. The water pressure operated massage apparatus of claim 6, wherein said first chamber includes at least one drain port in said first chamber, said at least one drain port conveying water from inside said first chamber to outside said housing.

9. The water pressure driven massage apparatus of claim 3, wherein:
said source of water pressure comprises a delivery hose removably attached at one end to said nozzle;
said delivery hose having a second end removably attached to a water supply outlet.

10. The water pressure driven massage apparatus of claim 9, wherein:
said water supply outlet comprises a multi-position shower diverter valve having a first position delivering water to a shower head, a second position delivering water to said delivery hose, and a third position simultaneously delivering water to both said shower head and said delivery hose.
